(19) United States
(12) Patent Application Publication
(10) Pub. No.: US 2002/0147812 A1
(43) Pub. Date: Oct. 10, 2002

(54) System and method for enabling applet execution in networks utilizing proxy servers

(75) Inventor: Chad A. Schoettger, Louisville, CO (US)

Correspondence Address: LAHIVE & COCKFIELD, 28 STATE STREET, BOSTON, MA, 02109, US

(73) Assignee: SUN MICROSYSTEMS, INC.

(21) Appl. No.: 09/829,737

(22) Filed: Apr. 10, 2001

(51) Int. Cl. G06F 15/173

(52) U.S. Cl. 709/225

(57) ABSTRACT

A method for enabling applet execution in networks using proxy servers is disclosed. An applet not requiring a Domain Name Server (DNS) lookup is embedded into a web page prior to the appearance of other applets in the web page. The web page is retrieved by a web browser and the first applet is used to verify network and web browser settings. The applet checks for the presence of a proxy server and verifies the proxy settings of the web browser. A warning is displayed to the user of the web browser if the proxy settings are not enabled.

### FIELD OF THE INVENTION

The illustrative embodiment of the present invention relates generally to software and more particularly to the enabling of applet execution over networks utilizing proxy servers.

### BACKGROUND OF THE INVENTION

Web browsers, such as Netscape Navigator, from Netscape Communication Corporation, of Palo Alto, Calif., retrieve web pages and execute content (if any) contained in the web pages. The web pages are usually stored on a web server accessible over a network. The web pages are written in a markup language, such as the Hypertext Markup Language (HTML) or the Extensible Markup Language (XML) and contain information which is interpreted for display to a user by the web browser.

The majority of documents available on the Internet today are stored in HTML. HTML is a markup language that encodes a document via the use of tags and attributes. Tags appear between < > brackets, and attributes are specified in the form of “name=value”. HTML specifies the meaning of each tag and attribute and how text located between tags and/or attributes will appear. An example is a tag <p> which designates the beginning of a new paragraph. A corresponding tag </p> designates the end of the paragraph. HTML documents are typically interpreted by HTML interpreters found in web browsers. Some web pages today are written in a another markup language, XML. XML was developed to provide greater flexibility for applications utilizing electronic documents. Similar to HTML, XML is a markup language that uses tags and attributes, but unlike HTML, XML uses tags only to delimit pieces of data. The interpretation given to the meaning of the data is left up to the application that reads the data. As noted above, the tag <p> in HTML specifies that a new paragraph is needed, whereas the tag <p> in XML has an application specific meaning. This flexibility allows applications making use of the data to interpret the data in different ways. The presentation of the data is separated from the content. Web browsers equipped with XML interpreters can translate and present XML web pages.

Conventionally, a user launches a web browser to view web pages over a network. The web browser may be part of an application suite, such as Netscape Communicator, from Netscape Communications Corporation, or it may be a stand-alone application such as Netscape Navigator. The browser retrieves the web page, interprets it, and displays it to a user. While interpreting the web page, the browser may encounter an indication of an embedded “applet”. The indication is a tag “<applet >”. An “applet” is a program designed to be executed from within another application. Applets enable web pages to include advanced effects, such as moving graphics and sound. Applets may be written in a multitude of languages, but many applets are written in Java (Java is a trademark or registered trademark of Sun Microsystems, Inc. of Palo Alto, Calif. in the U.S. and in other countries).

Java is an object oriented language specifically developed to provide cross platform capability. The Java software architecture is designed to support platforms ranging from personal computers to embedded network devices. The Java language was created by Sun Microsystems, Inc. The object linking and embedding characteristics of Java make it possible to create Java applets. Web browsers which are equipped with Java virtual machines (JVMs), can interpret the Java applets.

Once the web browser interpreter encounters a Java applet, the browser retrieves the code for the applet from an indicated source. The source for the applet may be the original location of the web page, which is often a web server. Alternatively, the source may be a different remote source accessible over the network for which a uniform resource locator (URL) address is provided. The retrieved code is fed to the JVM for execution. The result of the code execution may (in some instances) be shown by the web browser in the display presented to the user. This embedding of code enables whole programs to be included within a single web page merely by including a small applet to indicate the code source.

Many applets are composed of multiple Java class files or Jarer class files. A “Jarer class” is a class within JAVA that is utilized in creating jar (JAR) files. JAR files are compressed versions of JAVA files. Prior to retrieving the applet code from its source, the web browser first performs a domain name server (DNS) lookup to confirm the identity of the applet source by obtaining the DNS/IP (Internet Protocol) address on the external host. In many company networks operating behind a firewall, the ability of the web browser to perform a DNS lookup for external hosts directly is disabled, and all external traffic is routed through a proxy. Each user of the local network makes contact with the Internet by sending traffic through the proxy. Proxies use textual name equivalence to determine if a connection to an external applet source can be established. Textual name equivalence gives the “name of the home” address to be relied on by the browser rather than the stricter DNS/IP address.

IP addressing is described in more detail below. The web browser must be configured to accept the results of the textual name equivalence performed by the proxy which is used to generate the applet source address. In situations where the applet is composed of multiple Java class files or JAR files, the browser is operating behind a firewall, and the proxy setting is not enabled, the browser often cannot establish a socket connection back to the applet's source code with the result that the applet code is not retrieved. The user watching the displayed web page will not see the web page displayed as the web page was envisioned by its creator without the failed applet.

### SUMMARY OF THE INVENTION

The illustrative embodiment of the present invention provides a method of detecting web browser proxy settings that are preventing the proper execution of applets embedded in retrieved web pages. The method of the present invention discloses embedding a first applet composed of a single class in a web page along with a second applet. When the web page is retrieved by the web browser, the first applet checks the browser setting to determine if a proxy server is being utilized by the browser and if the browser is configured to accept the results of the proxy textual name equivalence conversion. . If a proxy server is being used and the proxy setting is not enabled, the method displays a message to the browser user.

Hereafter, the setting enabling the web browser to accept the results of the proxy textual name equivalence conversion shall be referred to as the “trust proxy setting”.

In one embodiment of the present invention a first Java applet comprised of a single class is stored on a web page accessible over a computer network. The web page also includes a second Java applet. The web page is retrieved by a web browser running on a computer system which is connected to the network. The first Java applet is executed by a Java Machine (JVM) connected to the browser and checks for the presence of a proxy server on the local network. If the local network is using a proxy server, the applet checks to see if the browser trust proxy setting is enabled. If the local network the computer system is attached to uses a proxy server to connect to the Internet, and the trust proxy setting for the browser is not enabled, the first Java applet causes a notification regarding the trust proxy setting to be displayed to the user of the browser.

In another embodiment of the present invention, a first Java applet comprised of a single class is stored on a web page accessible over a computer network. The web page also includes a second Java applet. The web page is retrieved by a web browser running on an electronic device which is connected to the network. The first Java applet is executed by a JVM connected to the browser and checks for the presence of a proxy server on the local network. If the local network is using a proxy server, the applet checks to see if the browser trust proxy setting is enabled. If the local network the electronic device is attached to uses a proxy server to connect to the Internet, and the trust proxy setting for the browser is not enabled, the first Java applet causes a notification to be displayed to the user of the browser.

In an alternative embodiment of the present invention, a first applet is stored on a web page accessible over a network. The web page also includes a second applet. The web page is retrieved by a web browser running on an electronic device which is connected to the network. The first applet is executed and checks the browser trust proxy setting. The first applet is executed and checks for the presence of a proxy server on the local network. If the local network is using a proxy server, the applet checks to see if the browser trust proxy setting is enabled. If the local network the electronic device is attached to uses a proxy server to connect to the Internet, and the trust proxy setting for the browser is not enabled, the first applet causes a notification to be displayed to the user of the browser.

### BRIEF DESCRIPTION OF THE DRAWINGS

FIG. 1 depicts a block diagram of an environment suitable for practicing the illustrative embodiment of the present invention;

FIG. 2 is a flow chart of the steps followed by a web browser in retrieving and displaying web pages;

FIG. 3 is a flow chart of the sequence of steps followed by the illustrative embodiment of the present invention in determining proxy settings in web browsers.

### DETAILED DESCRIPTION OF THE INVENTION

The illustrative embodiment of the present invention provides a method for detecting the cause of applet execution failure. The method of the illustrative embodiment embeds a first applet (composed of a single class) in a web page along with a second applet. When the web page is retrieved by the web browser, the first applet checks to determine if a proxy server is being utilized by the network and if the trust proxy setting is enabled on the web browser. If a proxy server is being used and the trust proxy setting is not enabled, the method displays a message to the browser user indicating the trust-proxy setting as the likely cause of applet failure.

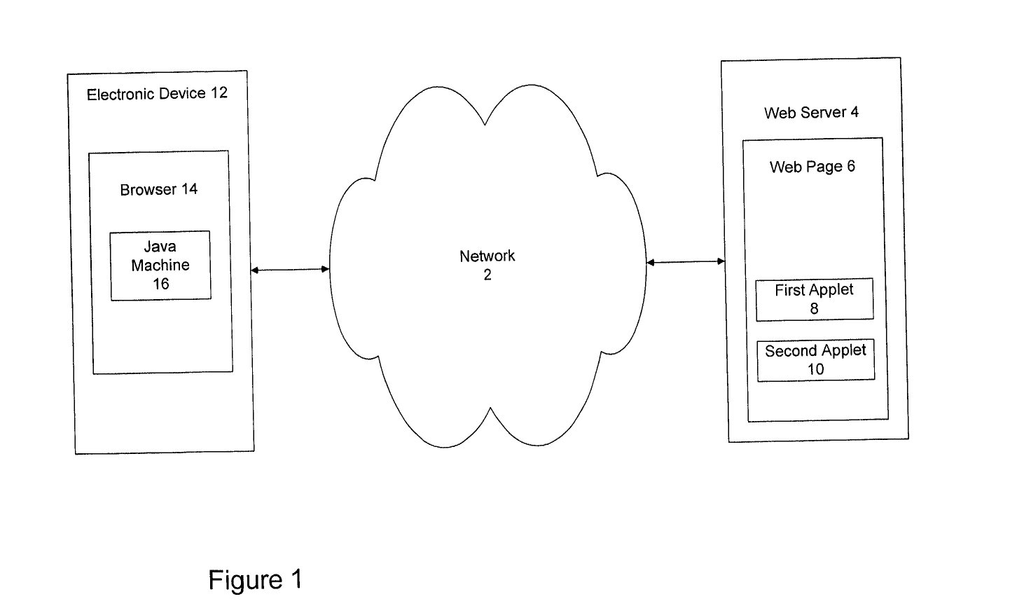

FIG. 1 depicts an environment suitable for practicing the illustrative embodiment of the present invention. A network 2, such as the Internet, is interfaced with a web server 4. The network 2 may also be a wireless network, a local area network (LAN) interfaced with another network, or some other type of network that directs internal traffic through a proxy server enroute to an external location. The web server 4 stores a web page 6 that includes a first applet 8 and a second applet 10. An electronic device 12 is also interfaced with the network 2. The electronic device 12 may be a desktop computer system, PDA, handheld wireless device, laptop or other device interfaced with the network 2. The devices may be physically connected or connected using wireless technology. The electronic device 12 also includes a web browser 14. The web browser 14 includes a virtual JVM 16.

When a web browser interpreter encounters an applet tag, it ordinarily attempts to perform a DNS lookup of the address indicated as the source of the applet code. A DNS lookup reconciles the applet code source address with a list of domain addresses. In the current Internet addressing format (i.e.: IPv4), an Internet address (“IP address”) is a four byte address which includes a network portion and a host portion. The network portion of the address is one to three bytes in length (depending on the size of the network) and identifies the particular network. The host portion of the address is the inverse of the network length (ie: if the network portion of the address is three bytes the host portion is one byte; if the network portion of the address is one byte the host portion is three bytes) and identifies a particular device on the particular network.

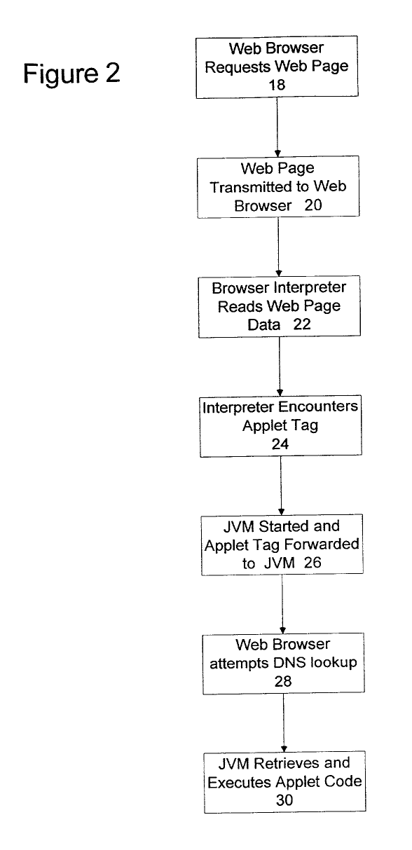

FIG. 2 is a flowchart of the steps taken by a web browser to retrieve and execute a web page. The web browser 14 receives an address from a user and sends a request for a web page to the address (step 18). The web page is transmitted to the web browser (step 20). The web browser uses a built-in interpreter, usually an HTML or XML interpreter, to read the data from the transmitted web page (step 22). The interpreter reads the web page until it encounters an applet tag (step 24). The browser then starts the JVM 16 and gives the applet tag to the JVM 16 (step 26). The applet tag includes a reference to the source of code for the applet. The JVM 16 attempts to verify the indicated applet address by performing a DNS lookup (step 28). If the lookup is successful and the address is verified, the web browser 14 retrieves the code from the source and gives it to the JVM 16 for execution (step 30). The results of the applet execution are displayed to the web browser user.

Corporate networks operating from behind a firewall for security purposes usually disable the ability of web browsers to perform DNS lookups for external hosts. External hosts are hosts that are not part of the corporate network. Since web browsers perform DNS lookups for multiple class applets and compressed file applets in order to verify applet source code addresses prior to retrieving the applet code, this can prevent applet execution. Web browsers running from behind a firewall are forced to use a proxy server to connect to the Internet. The proxy server acts as a funnel that channels all of the corporate network Internet requests through a single access point. The proxy server performs textual name equivalence checks to verify IP addresses. However, if the web browser has not been configured to accept the results of the textual name equivalence check, the browser will be unable to verify the applet source code address. If the browser is unable to verify the applet source code address, the applet fails to execute. Conventionally, the user of the browser may be unaware of the cause of the applet failure

The illustrative embodiment of the present invention identifies trust proxy settings in a web browser. If the settings are enabled, applets may be executed properly from behind a corporate firewall. If the settings are not enabled, the web browser user is informed of the settings to enable the user to take appropriate action.

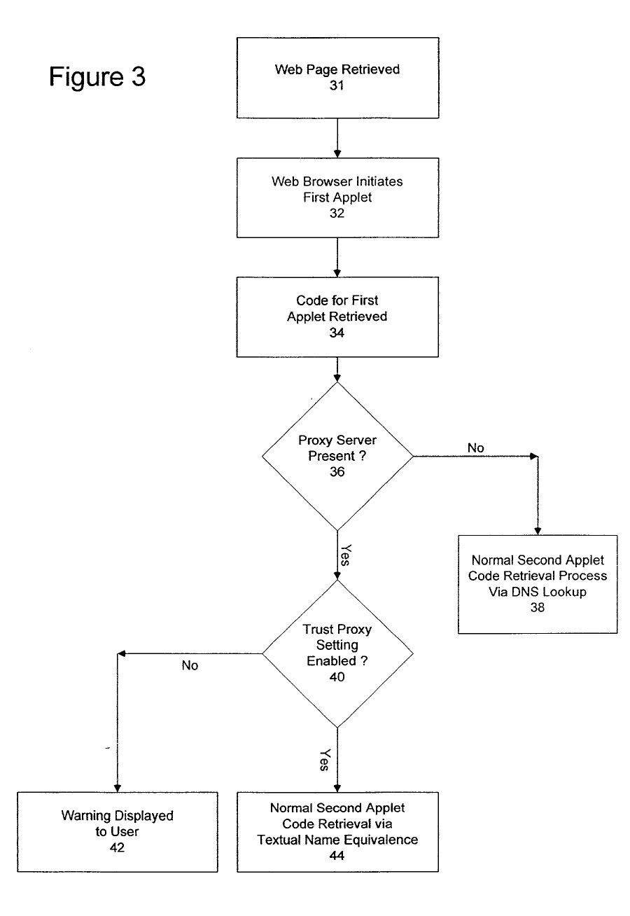

FIG. 3 is a flowchart of the sequence of steps utilized by the illustrative embodiment to determine web browser trust proxy settings. A web page 6 including applet one 8 and applet two 10 embedded in the web page is interfaced with a network 2. The web browser 14 retrieves the web page 6 over the network 2 (step 31). The web browser 14 interprets the web page 6 until it comes to an applet tag for a first applet 8 which it initiates (step 32). The first applet 8 is a Java applet comprised of a single Java class which does not require a DNS lookup. The web browser 14 retrieves the source code for the first applet 8 from the source indicated (step 34) and gives it to the JVM 16. The code for the first applet 8 checks to see if a proxy server is being utilized on the local network (step 36). If there is no proxy server being utilized, the web browser will proceed with a normal DNS lookup to retrieve the source code for a second applet 10 (step 38). If there is a proxy server being utilized, the code for the first applet 8 checks to see if the web browser has enabled the trust proxy setting (step 40). If the trust proxy setting is not enabled, a warning is displayed to the web browser user (step 42). If the trust proxy setting is enabled, the web browser 14 retrieves the code for a second applet 10 after verifying the source code address provided by the proxy server using textual name equivalence (step 44).

It will thus be seen that the invention efficiently attains the objects made apparent from the preceding description. Since certain changes may be made without departing from the scope of the present invention, it is intended that all matter contained in the above description or shown in the accompanying drawings be interpreted as illustrative and not in a literal sense. Practitioners of the art will realize that the network configurations depicted and described herein are examples of the multiple possible network configurations that fall within the scope of the current invention.

We claim:

1. In a network, a method comprising the steps of:
providing a web page with a first and second embedded software facility, said first embedded software facility including a reference to a source of computer-executable code for determining the trust proxy setting in a web browser, said second embedded software facility including a reference to a source of computer-executable code;
receiving a request for said web page from a web browser; and
forwarding said web page to said web browser in response to said request.

2. The method of claim 1 wherein said computer-executable code referenced by said first embedded software facility is stored at a remote location from said web page.

3. The method of claim 1 wherein said computer-executable code referenced by said second embedded software facility is stored at a remote location from said web page.

4. In a network, a method comprising the steps of:
providing a web browser, said web browser stored on an electronic client device interfaced with said network, said web browser including settings for network connections;
retrieving a web page with said web browser, said web page including a first and second software facility stored therein, said first software facility including a reference to a source of computer-executable code for determining the trust proxy setting in said web browser;
retrieving the code for said first software facility; and
determining the trust proxy setting in the network settings of said web browser by executing the code for said first software facility.

5. The method of claim 4 wherein said the execution of the code referenced by said first software facility causes the trust proxy setting of said browser to be displayed to a user of said electronic client device as part of a notification that said trust proxy setting is not enabled.

6. The method of claim 4 wherein said second software facility stored on said web page is a Java applet composed of multiple classes.

7. The method of claim 4 wherein said second software facility stored on said web page is a jar file.

8. The method of claim 4 wherein both said first and second software facilities are Java applets.

9. The method of claim 4 wherein said computer-executable code referenced by said first embedded software facility is stored at a remote location from said web page.

10. The method of claim 4 wherein said computer-executable code referenced by said second embedded software facility is stored at a remote location from said web page.

11. In a network, a method for executing applets, said method comprising the steps of:
providing a web browser, said web browser stored on an electronic client device interfaced with said network, said web browser including settings for network connections;
providing a first applet and second applet stored on a web page accessible over said network, said first applet including a reference to a source of computer-executable code for determining the trust proxy setting in said web browser;
retrieving said web page with said web browser, said web browser initiating execution of said first applet; and
determining the trust proxy setting in the network settings of said web browser as a result of the execution of said first applet.

12. The method of claim 11 wherein said first applet displays said trust proxy setting to a user of said web browser as part of a notification that said trust proxy setting is not enabled.

13. The method of claim 11 wherein said applets are Java applets.

14. The method of claim 11 said second applet is composed of multiple classes.

15. The method of claim 11 wherein said second applet is a compressed file.

16. The method of claim 11 wherein the code for said first applet is stored at a remote location from said web page.

17. In a computer network, a first and second medium holding computer-executable instructions for a method, said method comprising the steps of:
providing a web page with a first and second embedded software facility, said first embedded software facility including a reference to code stored in said first medium, said first medium holding computer-executable code for determining the trust proxy setting in a web browser, said second embedded software facility including a reference to code stored in said second medium;
receiving a request for said web page from a web browser; and forwarding in response to said request said web page.

18. The first medium of claim 17, wherein said first medium is located remotely from said web page storage location.

19. The second medium of claim 17 wherein said second medium is located remotely from said web page storage location.

20. The mediums of claim 17 wherein both said first medium and said second medium are located remotely from said web page.

21. In a network, a method comprising the steps of:
providing a first web page with a first embedded software facility, said first embedded software facility including a reference to a source of computer-executable code for determining the trust proxy setting in a web browser;
providing a second web page with a second embedded software facility, said second embedded software facility including a reference to a source of computer-executable code;
receiving a first request for said first web page from a web browser;
forwarding said first web page to said web browser in response to said first request;
receiving a second request for said second web page from said web browser after the execution of said first embedded software facility, said execution indicating the proxy setting in said web browser is enabled; and
forwarding said second web page to said web browser in response to said second request;

22. The method of claim 21 wherein said computer-executable code referenced by said first embedded software facility is stored at a remote location from said first web page.

23. The method of claim 21 wherein said computer-executable code referenced by said second embedded software facility is stored at a remote location from said second web page.
